(19) United States
(12) Patent Application Publication
(10) Pub. No.: US 2014/0319402 A1
(43) Pub. Date: Oct. 30, 2014

(54) FLUID VALVE

(71) Applicant: Ronald Alan Gatten, Pleasanton, CA (US)

(72) Inventor: Ronald Alan Gatten, Pleasanton, CA (US)

(21) Appl. No.: 14/250,152

(22) Filed: Apr. 10, 2014

Related U.S. Application Data
(60) Provisional application No. 61/810,440, filed on Apr. 10, 2013.

(51) Int. Cl. F16K 3/02

(52) U.S. Cl. CPC F16K 3/02
USPC 251/324

(57) ABSTRACT

A valve assembly is provided including a generally hollow cylinder coupled to an axially aligned piston chamber. The cylinder defines an internal void extending from one side of the cylinder to another side of the cylinder. The cylinder includes at least one fluid inlet path and at least one fluid outlet path. A shuttle is arranged within the internal void of the cylinder. The shuttle is slidable between a first position and a second position around an axially located piston rod of the piston chamber. A generally sealed chamber exists between a portion of the shuttle and the cylinder. When the shuttle is in the second position, the chamber fluidly couples the fluid inlet path and the fluid outlet path to provide a controllable fluid flow into and out of the cylinder.

### CROSS REFERENCE TO RELATED APPLICATIONS

This application claims priority to U.S. Provisional Patent Application Ser. No. 61/810,440, filed Apr. 10, 2013, the contents of which are incorporated herein by reference thereto.

### BACKGROUND OF THE INVENTION

Pilot valves are commonly used to provide fluid flow to actuate larger flow valves which can control higher flow rates. The fluid being controlled is most often compressed gas or hydraulic fluid.

While existing valves are suitable for their intended purpose, the need for improvement remains, particularly in providing a pilot control valve that may utilize the structural features of a common piston cylinder to support and actuate the valve.

### BRIEF DESCRIPTION OF THE INVENTION

According to one embodiment of the invention, a valve assembly is provided including a generally hollow cylinder coupled to an axially aligned piston chamber. The cylinder defines an internal void extending from one side of the cylinder to another side of the cylinder. The cylinder includes at least one fluid inlet path and at least one fluid outlet path. A shuttle is arranged within the internal void of the cylinder. The shuttle is slidable between a first position and a second position around an axially located piston rod of the piston chamber. A generally sealed chamber exists between a portion of the shuttle and the cylinder. When the shuttle is in the second position, the chamber fluidly couples the fluid inlet path and the fluid outlet path to provide a controllable fluid flow into and out of the cylinder.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a view of a pilot valve assembly coupled to a common piston cylinder according to another embodiment of the present invention in a first state;

FIG. 1A is a cross-sectional view of the pilot valve assembly coupled to a common piston cylinder, the pilot valve being in a first state according to an embodiment of the invention;

FIG. 2 is a view of the pilot valve assembly of FIG. 1 in a second state; and

FIG. 2A is a cross-sectional view of the pilot valve assembly coupled to a common piston cylinder, the pilot valve being in a second state according to an embodiment of the invention.

The detailed description explains embodiments of the invention, together with advantages and features, by way of example with reference to the drawings.

### DETAILED DESCRIPTION OF THE INVENTION

Reference is made to the following U.S. patent application Ser. No. 13/448,340, filed on Apr. 16, 2012 the entire contents of which are incorporated herein by reference thereto. Reference is also made to U.S. Pat. No. 8,156,655, issued on Apr. 17, 2012, the entire contents of which are also incorporated herein by reference thereto. U.S. Pat. No. 8,156,655 also claims priority to U.S. Provisional Application Ser. No. 60/986,865 filed on Nov. 9, 2007, the entire contents of which are also incorporated herein by reference thereto.

In accordance with exemplary embodiments of the present invention, a fluid valve is disclosed. In an exemplary embodiment, the fluid valve is coupled to a common piston cylinder 1 and is configured to control a flow of compressed gas in a manner similar to a pneumatic switch when operated.

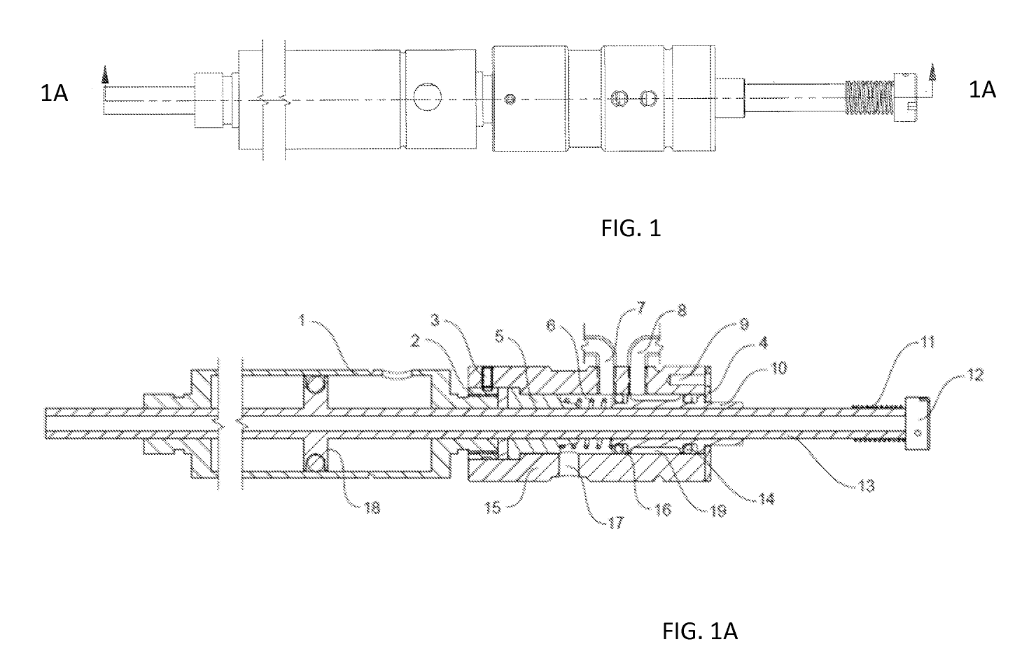

Referring now to FIGS. 1 and 1A, the illustrated fluid valve assembly 15 is shown axially located and attached to piston cylinder 1 by a plurality of threads 2 and a set screw 3. In one embodiment, the fluid valve assembly 15 functions as a pilot valve and the piston cylinder 1 is a portion of a pole saw as described in U.S. patent application Ser. No. 13/448,340 incorporated herein by reference. A pneumatic piston rod 13 slidably extends through the valve assembly 15 and is connected adjacent a first end to a piston 18 arranged within the chamber of the piston cylinder 1. An end effector nut 12 and a biasing mechanism 11, such as a spring for example, are mounted to the free end (e.g. opposite the piston 18) of the pneumatic piston rod 13. The biasing mechanism 11 may be configured to dampen the impact of contact between the end effector 12 and a portion of the valve assembly 15.

The valve assembly 15 includes a valve shuttle 10 that is slidable relative to an internal void within the cylinder of fluid valve assembly 15. As a result of the contour of the valve shuttle 10, an internal chamber 19 is formed by the space between the surface of the valve shuttle 10 and an internal surface of the valve assembly 15. The internal chamber 19 is fluidly coupled to a fluid inlet port 8 of the fluid valve assembly 15. Shuttle sealing members 14, 16, such as O-rings or an elastomeric diaphragm for example, are positioned adjacent the opposing ends of the valve shuttle 10 and are configured to seal any compressed gas within the internal chamber 19, thereby inhibiting gas flow beyond the chamber 19. Also, arranged within the valve assembly 15, in contact with an end of the pilot valve shuttle 10, is a biasing mechanism 6, such as a compression spring for example, mounted to a spring holder 5. When the fluid valve assembly 15 is in a first, non-operational state, as illustrated in FIGS. 1 and 1A, the biasing force of the biasing mechanism 6 applies a force to the slidable valve shuttle 10 such that the shuttle 10 is located in a first position, adjacent an end plate 4 connected to the valve assembly 15 with one or more fasteners 9. When in the first position, a portion of the valve shuttle 10 extends beyond the end plate 4 and the valve assembly 15.

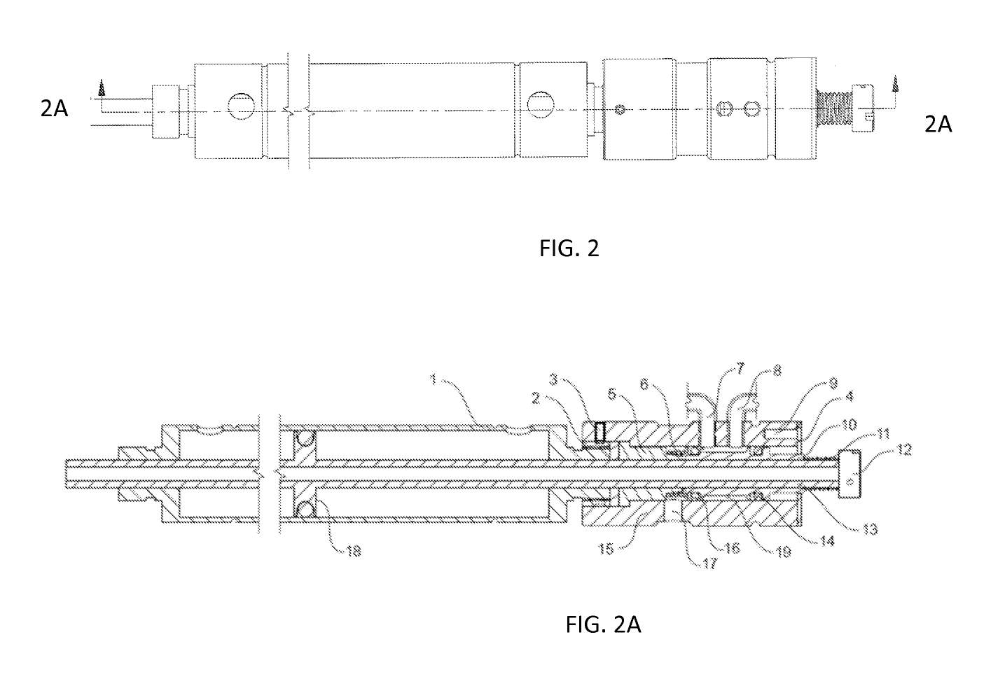

Referring now to FIGS. 2 and 2A, the valve assembly 15 is illustrated in a second, operational state. In an operational state, the valve shuttle 10 is in a second position, generally spaced away from the end plate 4, as shown in FIGS. 2 and 2A. The movement of the valve shuttle 10 to the second position causes the biasing mechanism 6 to at least partially compress against the spring holder 5. In addition, the biasing mechanism 11 surrounding the pneumatic piston rod 13 is in contact with the end of the valve shuttle 10. The fluid valve assembly 15 includes an exit port 7 positioned adjacent the inlet port 8. When the valve assembly 15 is in a second, operational state, the shuttle 10 is positioned such that the internal chamber 19 is fluidly coupled to both the inlet port 8 and the exit port 7. As a result of the flow path generated through the chamber 19 of the valve shuttle 10, the valve assembly 15 operates as a pneumatic switch.

The fluid valve assembly 15 is transformed from a non-operational state to an operational state by the motion of the piston 18 and the piston rod 13 within the piston cylinder 1. The gas flow and associated motion dynamics of a piston 18 within piston cylinder 1 are known to a person having ordinary skill in the art. In one embodiment, the cylinder of the fluid valve assembly 15 includes a vent hole 17 that allows any compressed gas from the motion of the valve shuttle 10 between the first position and the second position to escape without creating a backpressure that would inhibit movement of the shuttle 10.

The valve assembly 15 is configured to transition between the non-operation and operational states illustrated in the FIGS. When the pneumatic piston rod 13 is moved generally away from the fluid valve assembly 15, the biasing force applied by biasing mechanism 11 on the shuttle 10 is removed. In turn, by releasing the force applied to the shuttle 10, the internal biasing mechanism 6 will bias the valve shuttle 10 back to the first position adjacent the end plate 4. When the valve shuttle 10 returns to the first position, the sealing members 14 and 16 mounted on the valve shuttle 10 are repositioned to again inhibit compressed gas from flowing to exit port 7.

The valve assembly 15 typically actuates at the end of travel of the piston rod 13 when it has moved inwardly toward the piston body. In embodiments where it is desirable to actuate the valve assembly 15 prior to the end of inward travel of the piston rod 13, a spacer or spring, such as biasing mechanism 11 for example, is located around a portion of the piston rod 13 to actuate the valve assembly 15. Inclusion of a spacer or biasing mechanism 11 reduces the distance traveled before the actuating force supplied by piston rod 13 and end effector 12 contacts shuttle 10, and therefore reduces the travel distance required to transform the valve assembly 15 from a non-operational to an operational state.

The valve assembly 15 described herein is a fluid control valve that can function as a fluid switch. The valve assembly 15 utilizes the structural features of a common piston cylinder to support and to actuate the valve, thereby eliminating or substantially reducing the use of additional mounting and actuating hardware. In the exemplary embodiment, the valve assembly 15 is integrally mounted to a piston cylinder 1 and is actuated by the piston rod 13 thereof In addition, the physical relationship between piston cylinder 1 and valve assembly 15 substantially reduces the cost and complexity and alignment problems associated with prior art valves, which utilize additional hardware to separately mount and separately align valves. Another advantage is that the valve assembly 15 may be mounted on either or both ends of a dual ended piston cylinder 1, thereby providing gas switching flow signals at either or both ends, that is, any end of the piston cylinder 1 where the piston rod 13 protrudes.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A fluid valve assembly comprising:
a generally hollow cylinder coupled to an axially aligned piston chamber, the cylinder defining an internal void extending from one side of the cylinder to another side of the cylinder, wherein the cylinder includes at least one fluid inlet path and at least one fluid outlet path;
a shuttle arranged within the internal void of the cylinder, the shuttle being slidable between a first position and a second position around an axially located piston rod of the piston chamber, wherein a sealed chamber exists between a portion of the shuttle and the cylinder and when the shuttle is in the second position, the chamber is fluidly coupled to the fluid inlet path and the fluid outlet path to provide a controllable fluid flow into and out of the cylinder.

2. The fluid valve assembly of claim 1, wherein the fluid configured to flow into and out of the cylinder is compressed gas.

3. The fluid valve assembly of claim 1, wherein the valve functions as a pilot valve to actuate a larger fluid flow control valve.

4. The fluid valve assembly according to claim 1, wherein the axially aligned piston chamber is at least a portion of a pole saw.

5. The fluid valve assembly according to claim 1, wherein axial movement of the piston rod moves the shuttle between the first position and the second position.

6. The fluid valve assembly according to claim 1, further comprising:
a first biasing mechanism and a spring holder positioned adjacent the shuttle within the internal void, wherein when the shuttle is in the second position, the first biasing mechanism is at least partially compressed between the spring holder and the shuttle.

7. The fluid valve assembly according to claim 1, further comprising at least one o-ring configured to seal the chamber.

8. The fluid valve assembly according to claim 1, further comprising at least one elastomeric diaphragm configured to seal the chamber.

9. The fluid valve assembly according to claim 1, wherein the piston rod includes a biasing member adjacent a free end, the biasing member being in contact with the shuttle and applying a force thereto when the shuttle is in the second position.

10. The fluid valve assembly according to claim 1, wherein the cylinder includes a vent hole configured to reduce backpressure within the cylinder.
